(19) United States
(12) Patent Application Publication
(10) Pub. No.: US 2013/0006746 A1
(43) Pub. Date: Jan. 3, 2013

(54) TECHNIQUES FOR INTEGRATING SOCIAL NETWORKING REWARDS WITH THE RETAIL CHECKOUT PROCESS

(75) Inventor: David Eugene Moore, Lawrenceville, GA (US)

(73) Assignee: NCR Corporation, Duluth, GA (US)

(21) Appl. No.: 13/173,390

(22) Filed: Jun. 30, 2011

(51) Int. Cl. G06Q 30/00

(52) U.S. Cl. 705/14.33; 705/14.38

(57) ABSTRACT

A customer registers a social networking identifier with a retail loyalty program. When a customer completes a transaction at a retail establishment and provides a customer loyalty account number for the customer, a determination is made as to whether the customer can use social networking awards as part of the retail transaction.

### BACKGROUND

The proliferation of social networking has taken the world by surprise. Individuals are increasingly engaging in activities over the Internet. Furthermore, access to the Internet is easily achieved via mobile phones that virtually every adult and most children have and carry with them nearly everywhere they go. These mobile phones are also usually equipped with Global Positioning Satellite (GPS) receivers. As a result, social networking sites are now integrating the physical locations and actions of users with their services.

Some examples of such social networking sites include FourSquare™ and social location-based gaming sites, such as SCVNGR™ largely backed by Google™. These sites track the businesses or physical locations that customers have frequented and can also do comparisons to determine which of their participants frequent businesses the most often. These social networking services also encourage other members to visit the same businesses by providing current locations of friends while at the businesses and by providing business reviews from members.

SCVNGR™ also serves as a scavenger hunt type of activity, where customers are encouraged to visit and perform a challenge to earn points. These sites also encourage business interaction to attract customers.

Moreover, consumers are also increasingly using automated mechanisms to perform retail transactions. Kiosks exist to avoid enterprise personnel and lines. These automated kiosks allow consumers to perform transactions with an enterprise or agency with little to no human intervention.

Consumers can also earn rewards for using automated kiosks, such as a check-in kiosk for an airline. Consumers now also use their phones to complete transactions at retail establishments. So, there continues to be technological advancements in the retail industry to improve customer satisfaction and the checkout process in general.

However, the social networking technology and the self- service retail technology remain independent from one another with little to no integration with one another within the industry.

### SUMMARY

In various embodiments, techniques for integrating social networking rewards with the retail checkout process are presented. According to an embodiment, a method for integrating social networking awards with a retail transaction is discussed.

### BRIEF DESCRIPTION OF THE DRAWINGS

FIG. 1 is a diagram of a method for integrating social networking awards during a retail transaction is provided, according to an example embodiment.

FIG. 2 is a diagram of another method for integrating social networking awards during a retail transaction is provided, according to an example embodiment.

FIG. 3 is a diagram of a social networking and retail transaction award system, according to an example embodiment.

### DETAILED DESCRIPTION

The aforementioned industry problems are resolved by integrating social networking award programs with retail loyalty programs during retail transactions.

For example, in some embodiments presented herein and below, links are provided via Advanced Marketing Solutions (AMS) and NCR® SelfSery™ technologies that allow for automated integration of social networking reward programs during an automated retail checkout process. For example, a customer can register his/her FourSquare™ or SCVNGR™ member ids with their loyalty information on retail websites. So when retail personalization cards (loyalty cards) are swiped or entered during a transaction, the social networking services are dynamically contacted to determine if rewards can be returned to the customer due to their participation in one of these sites. Rewards can be coupons or just additional points back through the networking site. In the case of SCVNGR™, a simple quick challenge can be presented at the Self-Service Checkout (SSCO) that is reported back to the SCVNGR™ site. In each case, one goal can be to make the customer's visit more “fun” for purposes of encouraging retail loyalty program participation, and to encourage patronage by friends to increase visits to the retail establishments.

Integration of these social network programs via retail checkout services and self service lanes can allow the customer to get immediate rewards back through a Point-of-Sale (POS) system, thereby encouraging customers to use the POS system more frequently. Such integration also provides the retail business with an easy means of encouraging customers to come to the store without requiring cashiers or additional equipment to allow them to tap into the customer base for these services.

Although it is noted, that in some cases presented herein, integration of social networking awards can be used or encouraged by retailers during cashier-manned checkouts as well. That is, integration of social networking awards with the retail checkout process does not have to be exclusively tied to automated and self-service retail checkouts.

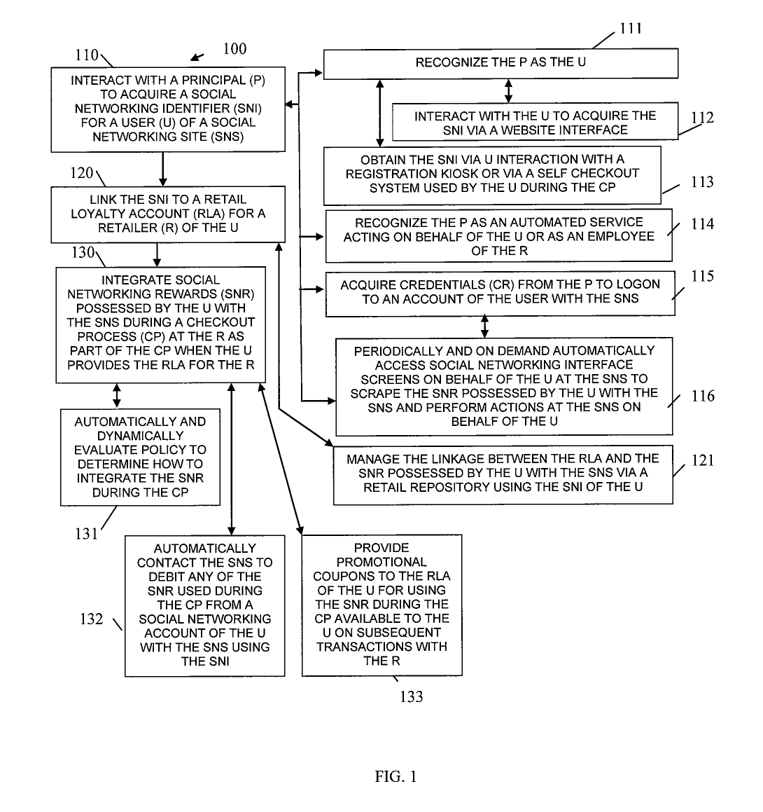

It is within this initial context that specific embodiments are now discussed with reference to the FIGS. 1-3.

FIG. 1 is a diagram of a method 100 for integrating social networking awards during a retail transaction is provided, according to an example embodiment. The method 100 (hereinafter “reward integration service”) is implemented as instructions programmed and residing on a non-transitory computer-readable (processor-readable) storage medium and executed by one or more processors. The processors are specifically configured and programmed to process the reward integration service. The reward integration service operates over a network; the network is wireless, wired, or a combination of wired and wireless.

At 110, the reward integration service interacts with a principal to acquire a social networking identifier for a user of a social networking site. The social networking site can be a location-based service or other type of service. Some example, location-based services include FourSquare™ and SCVNGR™ as discussed above. Some other services can include Twitter™, Facebook™, and the like. In fact, any social networking site that employs some type of award or reward program can be used as long as the user has an account with such service that the user is identified by with the social networking identifier.

Additionally, it is noted that although the processing of the reward integration service is discussed within the context of a single social networking site for the user; this does not have to always be the case. That is, the user can have a plurality of social networking subscriptions any of which or all of which can be used with the processing of the reward integration service.

According to an embodiment, at 111, the reward integration service recognizes the principal as being the user. Continuing with the embodiment of 111 and 112, the reward integration service interacts with the user to acquire the social networking identifier via a website interface. That is, at 112, the user can access a web site via a computer, phone, tablet, or other device to provide the user's social networking identifier for a particular social networking site.

Continuing still with the embodiment of 111 and at 113, the reward integration service obtains the social networking identifier via user interaction with a registration kiosk or a self-service checkout system used by the user during the checkout process at a retailer. In other words, a standalone kiosk can be deployed by the retailer to facilitate user registration of the social networking identifier and/or during the checkout process on the checkout system the user can be asked to register and/or use the social networking identifier.

In another case, at 114, the reward integration service recognizes the principal as an automated service acting on behalf of the user or as an employee of the retailer. For the first case (principal is an automated service), an application can automatically mine social networking sites with permission of the user (via a retailer website or via a form the user checks as part of the retailer loyalty program) for purposes of locating social networking sites that the user is registered with and to acquire the user's social networking identifier. In the second case (principal is an employee of the retailer), the employee interacts with the user or processes a paper form filled out by the user to register the user's social networking identifier on behalf of the user.

In an embodiment, at 115, the reward integration service also acquires credentials from the principal to logon to an account of the user with the social networking site. Of course, this would require permission of the user but permits the reward integration service to automatically access the user's social networking account by posing as the user on the social networking site.

So, continuing with the embodiment of 115 and at 116, the reward integration service can periodically and on demand automatically access social networking interface screens on behalf of the user at the social networking site. This is done to scrape social networking rewards possessed by the user with the social networking site, and this is done to perform actions on behalf of the user at the social networking site.

At 120, the reward integration service links the social networking identifier to a retail loyalty account for the retailer of the user. In other words, a mapping between the retailer's loyalty account for the user and the user's social networking account is maintained. Again, it is noted that the user can have multiple social networking accounts associated with a single retailer loyalty account (one-to-many relationship).

According to an embodiment, at 121, the reward integration service manages the linkage between the retail loyalty account and the social networking rewards possessed by the user with the social networking site via a retail repository and using the social networking identifier of the user for the social networking site.

At 130, the reward integration service integrates social networking rewards possessed by the user with the social networking site during a checkout process at the retailer and as part of the checkout process when the user provides retail loyalty account for the retailer. Usage of the social networking rewards can occur in a variety of customized and case-by-case situations or scenarios.

For example, at 131, the reward integration service automatically and dynamically evaluates policy (conditions and actions) to determine how to integrate the social networking rewards during the checkout process. Here, the retailer can customize how specific types of rewards are used during a transaction by defining policies that can be dynamically evaluated and followed by the reward integration service during the checkout process. The policies can be based on specific products, specific social networking sites, specific social networking rewards, specific types or levels of users that are part of the retailer's loyalty program, or various combinations of these things.

In one scenario, at 132, the reward integration service automatically and dynamically contacts the social networking site to debit any of the social networking rewards used during the checkout process from a social networking account of the user with the social networking site. This can be done via the social networking identifier of the user and perhaps via an Application Programming Interface (API) of the social networking site made available for the reward integration service to use to assist in integration of the social networking rewards with the retail checkout process. In other situations, an automated scrape can occur as discussed above to pose as the user on the social networking site, so the reward integration service acts as the user on the social networking site. This latter scenario can be used when a social networking site does not provide retailers with an API. So, the social networking site can be preconfigured to assist or can be entirely unaware of the usage of the social networking rewards by the reward integration service during the retail checkout process.

In yet another case, at 133, the reward integration service provides promotional coupons to the retail loyalty account of the user because the user integrated and used the social networking rewards during the retail checkout process. These coupons or incentives can be made available for the user to use on subsequent transactions with the retailer. In some cases, the coupons can be printed on a receipt at the checkout terminal during the checkout process. In other cases, the coupons can be credited to the retail loyalty account of the user and available in an automated fashion on subsequent checkouts by the user. Moreover, assuming the retailer and the social networking site has reciprocal pre-arranged relationships; some of the incentives can be related to usage or services of the social networking sites. So, integration of the retailer's promotions via the loyalty account can occur with the social networking site as well.

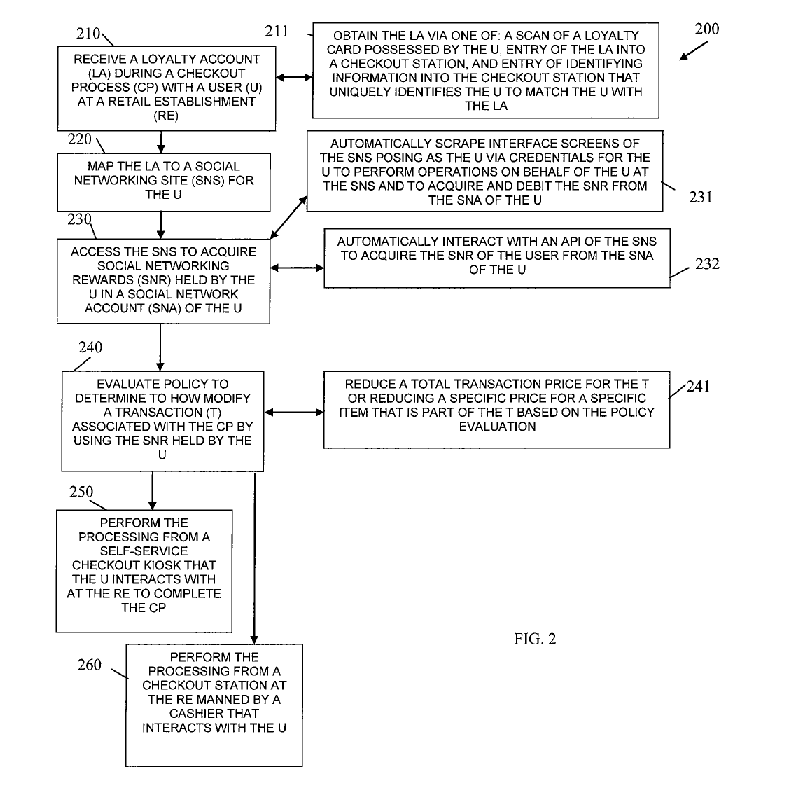

FIG. 2 is a diagram of another method 200 for integrating social networking awards during a retail transaction is provided, according to an example embodiment. The method 200 (hereinafter “reward manager”) is implemented as instructions and programmed within a non-transitory computer-readable (processor-readable) storage medium that executes on one or more processors, the processors are specifically configured to execute the reward manager. The reward manager is operational over a network; the network is wireless, wired, or a combination of wired and wireless.

The reward manager describes processing actions from the perspective of a consumer checkout for a transaction at a retail establishment. The customer has already social networking identifiers for the customer via the processing of the method 100 discussed above with respect to the FIG. 1.

At 210, the reward manager receives a loyalty account during a checkout process with a user at a retail establishment. Receipt of the loyalty account during the checkout process can occur in a variety of manners.

For example, at 211, the reward manager can obtain the loyalty account via one of: a scan of a loyalty card possessed by the user for the retail establishment, entry of the loyalty account into a checkout station by either the user or by an employee of the retail establishment, and/or entry of identifying information into the checkout station that uniquely identifies the user to match the user with the loyalty account (entered again by either the user or an employee of the retail establishment on behalf of the user).

At 220, the reward manager maps the loyalty account to a social networking site for the user. This can occur via a repository that the retailer maintains for the loyalty account of the user and was discussed in detail above with reference to the method 100 of the FIG. 1.

At 230, the reward manager accesses the social networking site to acquire social networking rewards (awards) held by the user in a social networking account of the user.

In one scenario, at 231, the reward manager automatically scrapes interface screens of the social networking site posing as the user via user credentials for the user to perform operations on behalf of the user at the social networking site and to acquire and debit the social networking rewards from the social networking account of the user.

In another scenario, at 232, the reward manager automatically interacts with an API of the social networking site to acquire the social networking rewards of the user from the social networking account of the user.

At 240, the reward manager evaluates policy to determine how to modify a transaction associated with the checkout process by using the social networking rewards held by the user. Policy permits a variety of retailer and/or social networking site defined conditions to be used and implemented in an automated fashion.

According to an embodiment, at 241, the reward manager reduces a total transaction price for the transaction or reduces a specific price for a specific item that is part of the transaction based on the policy evaluation. Of course, this is but one policy condition that can be configured to integrate the social networking rewards into the retail checkout process; many others can exist as well.

In an embodiment, at 250, the reward manager performs its processing from a self-service checkout kiosk that the user interacts with at the retail establishment to complete the checkout process. Here, there is no employee interaction needed and the user is self checking out of the retail establishment at the self-service checkout kiosk and the reward manager or a portion of the reward manager processes on the kiosk or is networked and interfaced to the kiosk.

In another case, at 260, the reward manager performs its processing from a checkout station at the retail establishment manned by a cashier that interacts with the user. It is noted that the user may partly interact independent of the cashier with some of the equipment at the checkout station as well (such as swiping loyalty card, credit card, etc.).

It is also noted that the embodiments of 250 and 260 are not mutually exclusive. That is, both embodiments can exist within the retail establishment.

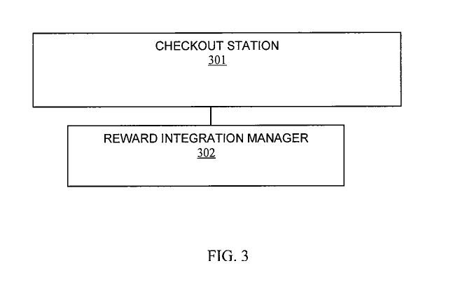

FIG. 3 is a diagram of a social networking and retail transaction award system 300, according to an example embodiment. The social networking and retail transaction award system 300 includes one or more processors that are specifically configured to perform, inter alia, the processing associated with the methods 100 and 200 of the FIGS. 1 and 2, respectively. Furthermore, the social networking and retail transaction award system 300 is operational over a network and the network can be wireless, wired, or a combination of wired and wireless. In an embodiment, the network is the Internet. In another case, the network is a cellular network. It may also be that the network uses both the Internet and a cellular network.

The social networking and retail transaction award system 300 includes a checkout station 301 and a reward integration manager 302. Each of these and their interactions with one another will now be discussed in turn.

The checkout station 301 includes a variety of equipment used to perform a checkout process at a retailer, such as touch screens, scanners, keypads, magnetic readers, weighing scales, cameras, audio equipment, and the like.

In an embodiment, the checkout station 301 is a self-service kiosk operated by the user during the checkout process. In another case, the checkout station 301 includes some equipment operated by a cashier and some equipment operated by the user during the checkout process.

The reward integration manager 302 is implemented, programmed, and resides within a non-transitory computer-readable storage medium and processed by one or more processors of the checkout station. Example aspects of the reward integration manager 302 were presented in detail above with respect to the methods 100 and 200 of the FIGS. 1 and 2, respectively. It is also noted that portions of the reward integration manager 302 can process on the checkout station 301 whereas other network portions of the reward integration manager 302 process on remote network equipment, which is interfaced to the checkout station 301.

The checkout station 301 is configured to perform a checkout process for a transaction of a user at a retail establishment. The reward integration manager 302 is configured to interact with a social networking site of the user to apply social networking rewards held by the user in a social networking account at the social networking site by the user during the checkout process and as part of the transaction. The social networking rewards are applied in accordance with policy evaluation performed by the reward integration manager 302.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors configured to execute the method, comprising:
interacting with a principal to acquire a social networking identifier for a user of a social networking site;
linking the social networking identifier to a retail loyalty account for a retailer of the user; and
integrating social networking rewards possessed by the user with the social networking site during a checkout process at the retailer as part of the checkout process when the user provides the retail loyalty account for the retailer.

2. The method of claim 1, wherein interacting further includes recognizing the principal as the user.

3. The method of claim 2, wherein recognizing further includes interacting with the user to acquire the social networking identifier via a website interface.

4. The method of claim 2, wherein recognizing further includes obtaining the social networking identifier via user interaction with a registration kiosk or via a self checkout system used by the user during the checkout process.

5. The method of claim 1, wherein interacting further includes recognizing the principal as an automated service acting on behalf of the user or recognizing the principal as an employee of the retailer.

6. The method of claim 1, wherein interacting further includes acquiring credentials from the principal to logon to an account of the user with the social networking site.

7. The method of claim 6, wherein acquiring further includes periodically and on demand automatically accessing social networking interface screens on behalf of the user at the social networking site to scrape the social networking rewards possessed by the user with the social networking site and perform actions at the social networking site on behalf of the user.

8. The method of claim 1, wherein linking further includes managing the linkage between the retail loyalty account and the social networking rewards possessed by the user with the social networking site via a retail repository using the social networking identifier of the user.

9. The method of claim 1, wherein integrating further includes automatically and dynamically evaluating policy to determine how to integrate the social networking rewards during the checkout process.

10. The method of claim 1, wherein integrating further includes automatically contacting the social networking site to debit any of the social network rewards used during the checkout process from a social networking account of the user with the social networking site using the social network identifier.

11. The method of claim 1, wherein integrating further includes providing promotional coupons to the retail loyalty account of the user for using the social network rewards during the checkout process available to the user on subsequent transactions with the retailer.

12. A processor-implemented method programmed in a non-transitory processor-readable medium and to execute on one or more processors configured to execute the method, comprising:
receiving a loyalty account during a checkout process with a user at a retail establishment;
mapping the loyalty account to a social networking site for the user;
accessing the social networking site to acquire social networking rewards held by the user in a social network account of the user; and
evaluating policy to determine to how modify a transaction associated with the checkout process by using the social networking rewards held by the user.

13. The method of claim 12 further comprising, performing the method from a self-service checkout kiosk that the user interacts with at the retail establishment to complete the checkout process.

14. The method of claim 12 further comprising, performing the method from a checkout station at the retail establishment manned by a cashier that interacts with the user.

15. The method of claim 12, wherein receiving further includes obtaining the loyalty account via one of: a scan of a loyalty card possessed by the user, entry of the loyalty account into a checkout station, and entry of identifying information into the checkout station that uniquely identifies the user to match the user with the loyalty account.

16. The method of claim 12, wherein accessing further includes automatically scrapping interface screens of the social networking site posing as the user via credentials for the user to perform operations on behalf of the user at the social networking site and to acquire and debit the social networking rewards from the social networking account of the user.

17. The method of claim 12, wherein accessing further includes automatically interacting with an application programming interface of the social networking site to acquire the social network rewards of the user from the social networking account of the user.

18. The method of claim 12, wherein evaluating further includes reducing a total transaction price for the transaction or reducing a specific price for a specific item that is part of the transaction based on the policy evaluation.

19. A system, comprising:
a checkout station; and
a reward integration manager implemented and residing on a non-transitory computer-readable storage medium and processed on one or more processors of the checkout station;
the checkout station is configured to perform a checkout process for a transaction of a user at a retail establishment, the reward integration manager is configured to interact with a social networking site of the user to apply social networking rewards held by the user in a social networking account at the social networking site by the user during the checkout process as part of the transaction, the social networking rewards applied in accordance with policy evaluation performed by the reward integration manager.

20. The system of claim 19, wherein the checkout station is a self-service kiosk operated by the user during the checkout process.
